(19) United States
(12) Patent Application Publication
(10) Pub. No.: US 2012/0072601 A1
(43) Pub. Date: Mar. 22, 2012

(54) APPARATUS AND METHOD FOR PROVIDING INTERNET PROTOCOL (IP) BASED SERVICES INDEPENDENT OF PLATFORM OR OPERATING SYSTEMS USING IP MULTIMEDIA SUBSYSTEM (IMS)

(75) Inventor: Murali B. Bharadwaj, San Diego, CA (US)

(73) Assignee: QUALCOMM INCORPORATED, San Diego, CA (US)

(21) Appl. No.: 12/883,389

(22) Filed: Sep. 16, 2010

(51) Int. Cl. G06F 15/16; H04B 7/00; H04L 12/28

(52) U.S. Cl. 709/228; 370/389; 370/310

(57) ABSTRACT

An apparatus and method for providing at least one Internet Protocol (IP) based service independent of platform or operating systems using IP multimedia subsystem (IMS), the method comprising implementing a call setup signaling and an end-to-end media transfer using an IP multimedia subsystem (IMS); and implementing the at least one Internet Protocol (IP) based service using the IP multimedia subsystem (IMS).

### FIELD

This disclosure relates generally to apparatus and methods for Internet Protocol (IP) based services in a wireless communication system. More particularly, the disclosure relates to providing Internet Protocol (IP) based services independent of platform or operating systems using IP multimedia subsystem (IMS).

### BACKGROUND

In many telecommunication systems, communications networks are used to exchange messages among several cooperating spatially-separated devices. The various types of communications networks may be classified in different aspects. In one example, the geographic scope of the network could be over a wide area, a metropolitan area, a local area, or a personal area, and the corresponding networks would be designated as wide area network (WAN), metropolitan area network (MAN), local area network (LAN), or personal area network (PAN). Networks also may be distinguished by the switching/routing technique used to interconnect the various network nodes and devices (e.g. circuit switching vs. packet switching), by the physical media employed for transmission (e.g. wired vs. wireless), or by the communication protocols used (e.g. Internet protocol suite, SONET (Synchronous Optical Networking), Ethernet, etc.).

One communications network feature is the choice of wired or wireless transport media for the transmission of electromagnetic signals among the constituents of the network. For wired networks, tangible physical media such as copper wire, coaxial cable, fiber optic cable, etc. are employed to propagate guided electromagnetic waveforms which carry message traffic over a distance. Wired networks are a static form of communications networks and are typically favored for interconnection of fixed network elements or for bulk data transfer. For example, fiber optic cables are often the preferred transmission media for very high throughput transport applications over long distances between large network hubs, such as, bulk data transport across or between continents over the Earth's surface.

On the other hand, wireless networks are usually preferred when the with mobile network elements which have dynamic connectivity needs or if the network architecture is formed in an ad hoc, rather than fixed, topology. Wireless networks employ intangible physical media in an unguided propagation mode using electromagnetic waves in the radio, microwave, infrared, optical, etc. frequency bands. Wireless networks have the advantage of facilitating user mobility and rapid field deployment compared to fixed wired networks. However, usage of wireless propagation requires significant active resource management among the network users and high levels of mutual coordination and cooperation for compatible spectrum utilization.

In one example, wireless networks are compatible with various wireless protocols. Example versions of wireless protocols include Universal Mobile Telecommunications System (UMTS), High Speed Downlink Packet Access (HSDPA), High Speed Uplink Packet Access (HSUPA), Long Term Evolution (LTE), etc. Wireless systems compliant with these protocols are used for various communication services such as telephony, messaging, data transfer, emails, Internet access, audio broadcasts, video communications, etc. These wireless systems generally utilize an access node (AN), also known as base station (BS) or Node B, to connect to an individual access terminal (AT), also known as user equipment (UE) or user device, to fixed telecommunications infrastructure networks. In general, a radio coverage area is implemented using a plurality of Node Bs using a cellular-based topological architecture to provide wireless access, also known as an air interface, to the UEs (e.g., user devices). Examples of fixed telecommunications infrastructure networks include the public switched telephony network (PSTN), Internet, private data networks, etc. In one aspect, the Node Bs may be connected to a Radio Network Controller (RNC) to facilitate the interconnection to the fixed telecommunications infrastructure networks.

### SUMMARY

Disclosed is an apparatus and method for providing Internet Protocol (IP) based services independent of platform or operating systems using IP multimedia subsystem (IMS). According to one aspect, a method for providing at least one Internet Protocol (IP) based service independent of platform or operating systems using IP multimedia subsystem (IMS), the method comprising implementing a call setup signaling and an end-to-end media transfer using an IP multimedia subsystem (IMS); and implementing the at least one Internet Protocol (IP) based service using the IP multimedia subsystem (IMS). In one aspect, the implementing the call setup signaling and the end-to-end media transfer step comprises one or more of the following: implementing a required IMS protocol for signaling and media; implementing an IMS framework for the call set up signaling and the end to end media transfer; enabling an end user application or a high level operating system (HLOS) specific telephony layer to support at least one legacy service using an IP-based network; implementing a high level operating system (HLOS) specific adaptation layer to enable at least one HLOS specific module to call into a native IMS application program interface (API); executing an IMS native service enabler engine for at least one legacy service over the IP-based network; managing 3^{rd} generation (3G)/4^{th} generation (4G) radio availability and unavailability and continuing to provide the at least one legacy service over either a circuit switched domain or an IP domain; or using an underlying 3G/4G data stack for IP-based legacy services.

According to another aspect, an apparatus for providing at least one Internet Protocol (IP) based service independent of platform or operating systems using IP multimedia subsystem (IMS), the apparatus comprising a processor and a memory, the memory containing program code executable by the processor for performing the following: implementing a call setup signaling and an end-to-end media transfer using an IP multimedia subsystem (IMS); and implementing the at least one Internet Protocol (IP) based service using the IP multimedia subsystem (IMS). In one aspect, the memory further comprises program code for implementing the call setup signaling and the end-to-end media transfer by performing one or more of the following: implementing a required IMS protocol for signaling and media; implementing an IMS framework for the call set up signaling and the end to end media transfer; enabling an end user application or a high level operating system (HLOS) specific telephony layer to support at least one legacy service using an IP-based network; implementing a high level operating system (HLOS) specific adaptation layer to enable at least one HLOS specific module to call into a native IMS application program interface (API); executing an IMS native service enabler engine for at least one legacy service over the IP-based network; managing 3^{rd} generation (3G)/4^{th} generation (4G) radio availability and unavailability and continuing to provide the at least one legacy service over either a circuit switched domain or an IP domain; or using an underlying 3G/4G data stack for IP-based legacy services.

According to another aspect, an apparatus for providing at least one Internet Protocol (IP) based service independent of platform or operating systems using IP multimedia subsystem (IMS), the apparatus comprising means for implementing a call setup signaling and an end-to-end media transfer using an IP multimedia subsystem (IMS); and means for implementing the at least one Internet Protocol (IP) based service using the IP multimedia subsystem (IMS). In one aspect, the means for implementing the call setup signaling and the end-to-end media transfer further comprises one or more of the following: means for implementing a required IMS protocol for signaling and media; means for implementing an IMS framework for the call set up signaling and the end to end media transfer; means for enabling an end user application or a high level operating system (HLOS) specific telephony layer to support at least one legacy service using an IP-based network; means for implementing a high level operating system (HLOS) specific adaptation layer to enable at least one HLOS specific module to call into a native IMS application program interface (API); means for executing an IMS native service enabler engine for at least one legacy service over the IP-based network; means for managing 3^{rd} generation (3G)/4^{th} generation (4G) radio availability and unavailability and continuing to provide the at least one legacy service over either a circuit switched domain or an IP domain; or means for using an underlying 3G/4G data stack for IP-based legacy services

According to another aspect, a computer-readable medium storing a computer program for providing at least one Internet Protocol (IP) based service independent of platform or operating systems using IP multimedia subsystem (IMS), wherein execution of the computer program is for: implementing a call setup signaling and an end-to-end media transfer using an IP multimedia subsystem (IMS); and implementing the at least one Internet Protocol (IP) based service using the IP multimedia subsystem (IMS). In one aspect, the program code for implementing the call setup signaling and the end-to-end media transfer further comprises program code for one or more of the following: implementing a required IMS protocol for signaling and media; implementing an IMS framework for the call set up signaling and the end to end media transfer; enabling an end user application or a high level operating system (HLOS) specific telephony layer to support at least one legacy service using an IP-based network; implementing a high level operating system (HLOS) specific adaptation layer to enable at least one HLOS specific module to call into a native IMS application program interface (API); executing an IMS native service enabler engine for at least one legacy service over the IP-based network; managing 3^{rd} generation (3G)/4^{th} generation (4G) radio availability and unavailability and continuing to provide the at least one legacy service over either a circuit switched domain or an IP domain; or using an underlying 3G/4G data stack for IP-based legacy services.

Advantages of the present disclosure may include ability for providing IP services independent of computer platform or operating systems.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of an access node/user equipment (UE) system.

FIG. 2 illustrates an example of a wireless communications system that supports a plurality of users.

FIG. 3 illustrates an example of an IP multimedia subsystem (IMS) layer model.

FIG. 4 illustrates an example of a user device containing an applications processor along with a core processor.

FIG. 5 illustrates an example process for providing Internet Protocol (IP) based services independent of platform or operating systems using IP multimedia subsystem (IMS).

FIG. 6 illustrates an example flow diagram for providing Internet Protocol (IP) based services independent of platform or operating systems using IP multimedia subsystem (IMS).

FIG. 7 illustrates an example of a device comprising a processor in communication with a memory for executing the processes for providing Internet Protocol (IP) based services independent of platform or operating systems using IP multimedia subsystem (IMS).

FIG. 8 illustrates an example of a first device suitable for providing Internet Protocol (IP) based services independent of platform or operating systems using IP multimedia subsystem (IMS).

FIG. 9 illustrates an example of a second device for providing Internet Protocol (IP) based services independent of platform or operating systems using IP multimedia subsystem (IMS).

FIG. 10 illustrates an example processor configuration with both a modem processor and an application processor for providing Internet Protocol (IP) based services independent of platform or operating systems using IP multimedia subsystem (IMS).

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). Cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

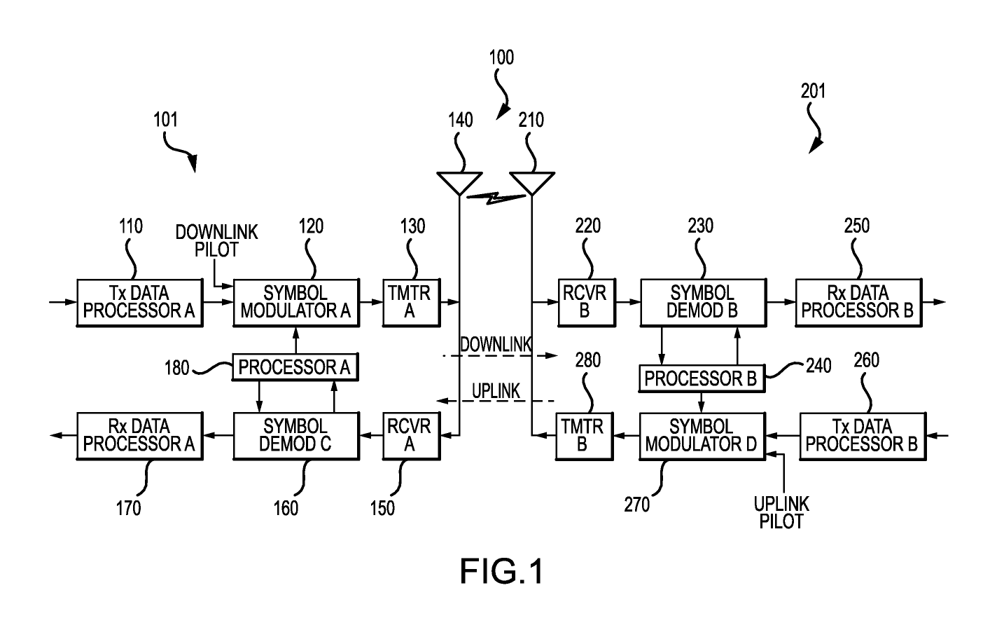

FIG. 1 illustrates an example of an access node/user equipment (UE) system 100. One skilled in the art would understand that the example access node/UE system 100 illustrated in FIG. 1 may be implemented in an FDMA environment, an OFDMA environment, a CDMA environment, a WCDMA environment, a TDMA environment, a SDMA environment or any other suitable wireless environment.

The access node/UE system 100 includes an access node 101 (e.g., base station) and a user equipment or UE 201 (e.g., wireless communication device). In the downlink leg, the access node 101 (e.g., base station) includes a transmit (TX) data processor A 110 that accepts, formats, codes, interleaves and modulates (or symbol maps) traffic data and provides modulation symbols (e.g., data symbols). The TX data processor A 110 is in communication with a symbol modulator A 120. The symbol modulator A 120 accepts and processes the data symbols and downlink pilot symbols and provides a stream of symbols. In one aspect, it is the symbol modulator A 120 that modulates (or symbol maps) traffic data and provides modulation symbols (e.g., data symbols). In one aspect, symbol modulator A 120 is in communication with processor A 180 which provides configuration information. Symbol modulator A 120 is in communication with a transmitter unit (TMTR) A 130. The symbol modulator A 120 multiplexes the data symbols and downlink pilot symbols and provides them to the transmitter unit A 130.

Each symbol to be transmitted may be a data symbol, a downlink pilot symbol or a signal value of zero. The downlink pilot symbols may be sent continuously in each symbol period. In one aspect, the downlink pilot symbols are frequency division multiplexed (FDM). In another aspect, the downlink pilot symbols are orthogonal frequency division multiplexed (OFDM). In yet another aspect, the downlink pilot symbols are code division multiplexed (CDM). In one aspect, the transmitter unit A 130 receives and converts the stream of symbols into one or more analog signals and further conditions, for example, amplifies, filters and/or frequency upconverts the analog signals, to generate an analog downlink signal suitable for wireless transmission. The analog downlink signal is then transmitted through antenna 140.

In the downlink leg, the UE 201 includes antenna 210 for receiving the analog downlink signal and inputting the analog downlink signal to a receiver unit (RCVR) B 220. In one aspect, the receiver unit B 220 conditions, for example, filters, amplifies, and frequency downconverts the analog downlink signal to a first “conditioned” signal. The first “conditioned” signal is then sampled. The receiver unit B 220 is in communication with a symbol demodulator B 230. The symbol demodulator B 230 demodulates the first “conditioned” and “sampled” signal (e.g., data symbols) outputted from the receiver unit B 220. One skilled in the art would understand that an alternative is to implement the sampling process in the symbol demodulator B 230. The symbol demodulator B 230 is in communication with a processor B 240. Processor B 240 receives downlink pilot symbols from symbol demodulator B 230 and performs channel estimation on the downlink pilot symbols. In one aspect, the channel estimation is the process of characterizing the current propagation environment. The symbol demodulator B 230 receives a frequency response estimate for the downlink leg from processor B 240. The symbol demodulator B 230 performs data demodulation on the data symbols to obtain data symbol estimates on the downlink path. The data symbol estimates on the downlink path are estimates of the data symbols that were transmitted. The symbol demodulator B 230 is also in communication with a RX data processor B 250.

The RX data processor B 250 receives the data symbol estimates on the downlink path from the symbol demodulator B 230 and, for example, demodulates (i.e., symbol demaps), deinterleaves and/or decodes the data symbol estimates on the downlink path to recover the traffic data. In one aspect, the processing by the symbol demodulator B 230 and the RX data processor B 250 is complementary to the processing by the symbol modulator A 120 and TX data processor A 110, respectively.

In the uplink leg, the UE 201 includes a TX data processor B 260. The TX data processor B 260 accepts and processes traffic data to output data symbols. The TX data processor B 260 is in communication with a symbol modulator D 270. The symbol modulator D 270 accepts and multiplexes the data symbols with uplink pilot symbols, performs modulation and provides a stream of symbols. In one aspect, symbol modulator D 270 is in communication with processor B 240 which provides configuration information. The symbol modulator D 270 is in communication with a transmitter unit B 280.

Each symbol to be transmitted may be a data symbol, an uplink pilot symbol or a signal value of zero. The uplink pilot symbols may be sent continuously in each symbol period. In one aspect, the uplink pilot symbols are frequency division multiplexed (FDM). In another aspect, the uplink pilot symbols are orthogonal frequency division multiplexed (OFDM). In yet another aspect, the uplink pilot symbols are code division multiplexed (CDM). In one aspect, the transmitter unit B 280 receives and converts the stream of symbols into one or more analog signals and further conditions, for example, amplifies, filters and/or frequency upconverts the analog signals, to generate an analog uplink signal suitable for wireless transmission. The analog uplink signal is then transmitted through antenna 210.

The analog uplink signal from UE 201 is received by antenna 140 and processed by a receiver unit A 150 to obtain samples. In one aspect, the receiver unit A 150 conditions, for example, filters, amplifies and frequency downconverts the analog uplink signal to a second “conditioned” signal. The second “conditioned” signal is then sampled. The receiver unit A 150 is in communication with a symbol demodulator C 160. One skilled in the art would understand that an alternative is to implement the sampling process in the symbol demodulator C 160. The symbol demodulator C 160 performs data demodulation on the data symbols to obtain data symbol estimates on the uplink path and then provides the uplink pilot symbols and the data symbol estimates on the uplink path to the RX data processor A 170. The data symbol estimates on the uplink path are estimates of the data symbols that were transmitted. The RX data processor A 170 processes the data symbol estimates on the uplink path to recover the traffic data transmitted by the wireless communication device 201. The symbol demodulator C 160 is also in communication with processor A 180. Processor A 180 performs channel estimation for each active terminal transmitting on the uplink leg. In one aspect, multiple terminals may transmit pilot symbols concurrently on the uplink leg on their respective assigned sets of pilot subbands where the pilot subband sets may be interlaced.

Processor A 180 and processor B 240 direct (i.e., control, coordinate or manage, etc.) operation at the access node 101 (e.g., base station) and at the UE 201, respectively. In one aspect, either or both processor A 180 and processor B 240 are associated with one or more memory units (not shown) for storing of program codes and/or data. In one aspect, either or both processor A 180 or processor B 240 or both perform computations to derive frequency and impulse response estimates for the uplink leg and downlink leg, respectively.

In one aspect, the access node/UE system 100 is a multiple-access system. For a multiple-access system (e.g., frequency division multiple access (FDMA), orthogonal frequency division multiple access (OFDMA), code division multiple access (CDMA), time division multiple access (TDMA), space division multiple access (SDMA), etc.), multiple terminals transmit concurrently on the uplink leg, allowing access to a plurality of UEs. In one aspect, for the multiple-access system, the pilot subbands may be shared among different terminals. Channel estimation techniques are used in cases where the pilot subbands for each terminal span the entire operating band (possibly except for the band edges). Such a pilot subband structure is desirable to obtain frequency diversity for each terminal

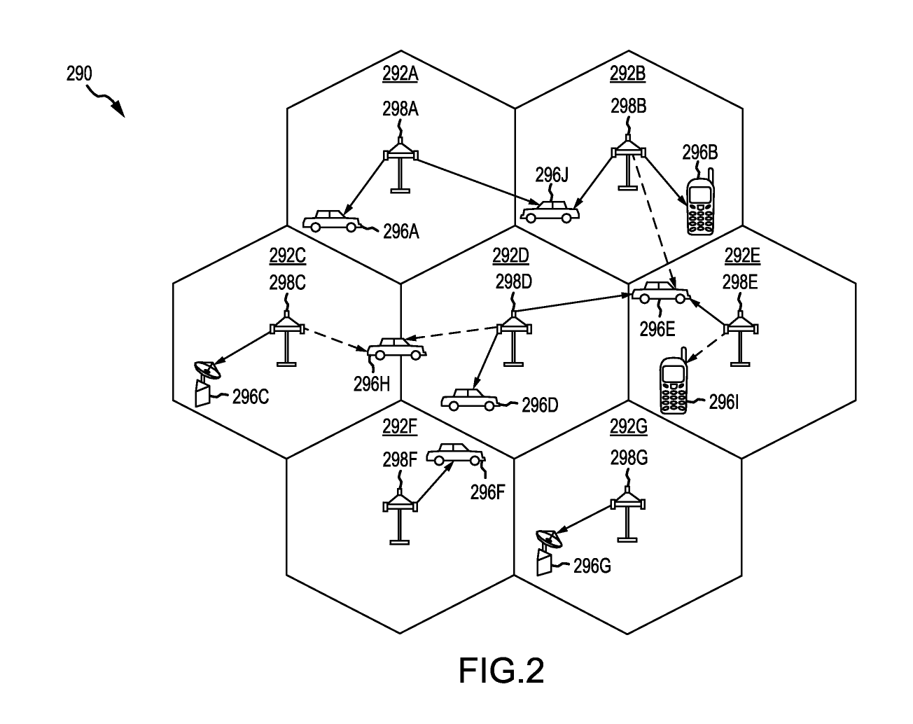

FIG. 2 illustrates an example of a wireless communications system 290 that supports a plurality of users (e.g., mobile user devices 296B, 2961). In FIG. 2, reference numerals 292A to 292G refer to cells, reference numerals 298A to 298G refer to base stations (BS) or base transceiver station (BTS) and reference numerals 296A to 296J refer to access User Equipments (UE) or mobile user devices. Cell size may vary. Any of a variety of algorithms and methods may be used to schedule transmissions in system 290. System 290 provides communication for a number of cells 292A through 292G, each of which is serviced by a corresponding base station 298A through 298G, respectively.

In one aspect, telecommunications providers desire a capability to provide a wide variety of user services, both legacy and new, over a common transport infrastructure. For example, existing telephony and video broadcast services, which currently use their own dedicated infrastructure, may be migrated to a common packet-switched network infrastructure based on IP. Usage of a common packet-switched network for a variety of legacy and new user services is also known as “network convergence” and facilitates the development of a universal core transport infrastructure for multiple user applications.

A potential advantage of the present disclosure is to provide a generic framework for providing legacy services on a wide range of high level operating systems which allows third party applications running in this user space to provide generic IP services. Also, legacy services may run on IMS based native service enablers over the IP domain. In one aspect, additional new applications may be hosted on an applications processor within the user device which is compatible with the existing 3^{rd} generation (3G) or 4^{th} generation (4G) data networks. Also, 3G/4G radio availability may be managed within the applications processor to provide seamless and transparent legacy services.

In one example, the IP Multimedia Subsystem (IMS) is a network architecture for implementing telephony and multimedia services using an IP-based network infrastructure. IMS facilitates the convergence of a variety of services over a common network infrastructure such as voice, video, data, images, etc. IMS may be used for both wired and wireless networks to promote convergence of both fixed and mobile networks.

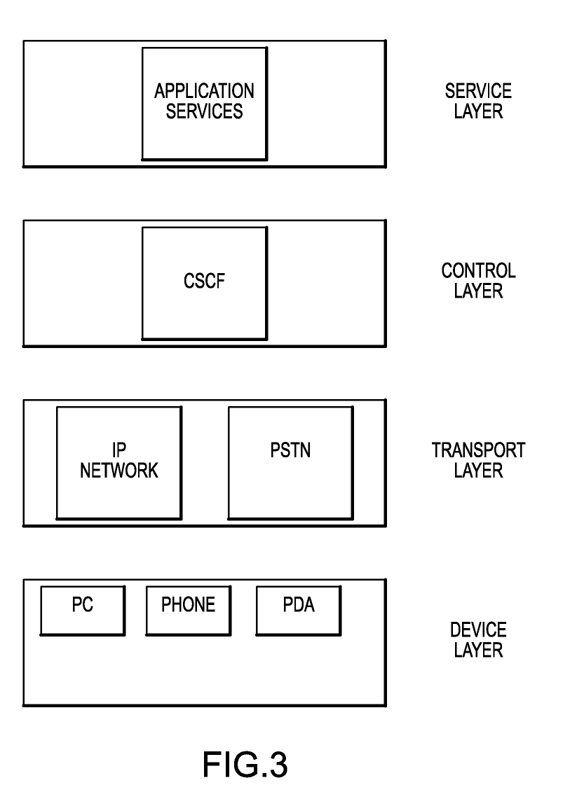

FIG. 3 illustrates an example of an IP multimedia subsystem (IMS) layer model. In one example, deployment of an IMS network may be viewed as a series of layers. The lowest layer, the device layer, consists of end user devices such as mobile phones, laptop computers, personal digital assistants (PDAs), smartphones, etc. The next layer, the transport layer, provides conversion between user data formats and IP network formats. The control layer, which resides on top of the transport layer, manages the communication sessions and handles signaling messages. Finally, the service layer, the uppermost layer, provides application services to the end users. In one aspect, IMS uses a Call Session Control Function (CSCF) for signaling and control using the Session Initiation Protocol (SIP). SIP may be used, for example, to create, modify and terminate communication sessions of media streams between users.

In one aspect, IMS includes quality of service (QoS) attributes. For example, QoS may be used to specify performance metrics such as bit rate, transport delay, jitter, loss probability, bit error rate (BER), etc. In another aspect, IMS may be used to implement legacy user services, such as voice telephony, short messaging service (SMS), video telephony, instant messaging (IM), etc. over an IP-based network infrastructure. In one example, IMS may be deployed on a variety of service platforms and operating systems.

In one aspect, IMS may be implemented on an applications processor within a user device, for example, mobile phone, smartphone, PDA, personal computer, etc. In one example, an applications processor is an additional computing resource within a user device which complements a core processor or baseband processor by providing application layer functions and services, such as multimedia applications. In another example, an applications processor may be implemented as an integral part of a core processor or baseband processor.

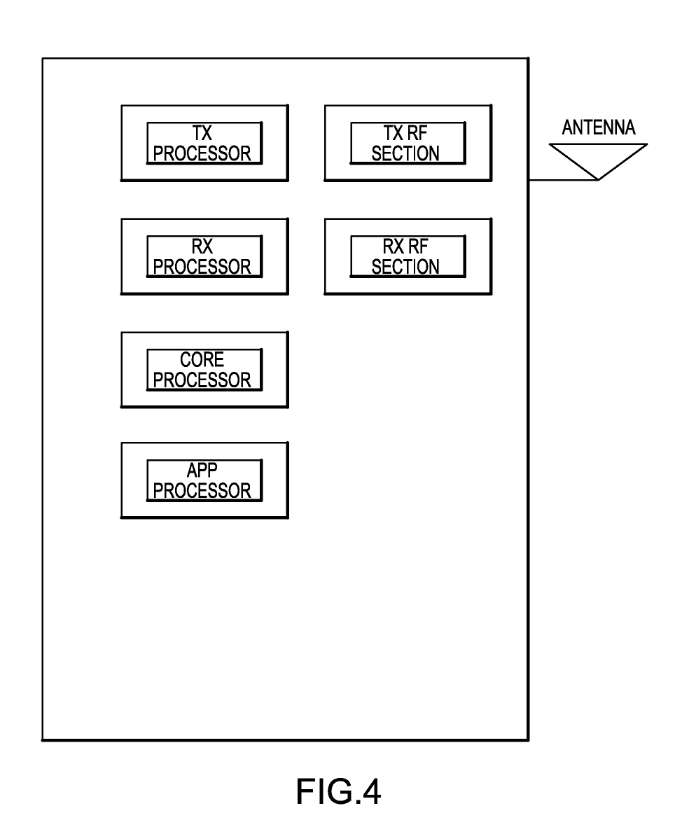

FIG. 4 illustrates an example of a user device containing an applications processor along with a core processor. In one aspect, an applications processor within a user device provides IMS framework for various user services. In one example, user services are legacy services. In another example, user services are new services.

In one example, the IMS framework provides one or more of the following functions to provide multimedia services on a common IP-based transport infrastructure:
Implement required IMS protocols for signaling using e.g. session initiation protocol (SIP) and session description protocol (SDP) and for media transport using e.g. real-time transport protocol (RTP), real-time transport control protocol (RTCP)
Implement IMS framework application program interface (API) based on standard JSR281 style APIs that enables native IMS applications and third party applications, either in native or user space, for call set up signaling and end-to-end media transfer. In one example, JSR281 is a Java Specification Requests document for an IMS services API
Implement IMS native application APIs in the user space to enable end user applications (e.g. Dialer, SMS Application, etc.) or high level operating system (HLOS) specific telephony layer to support legacy services such as voice, SMS, video telephony, etc. over the IP domain
Implement HLOS specific (e.g. Android, BREW, Windows Mobile (WM), etc.) adaptation layer to provide an interface implementation for HLOS specific modules such as telephony layer, end user applications written on top of the HLOS to call into native IMS application APIs
Implement IMS native service enabler engines for legacy services such as voice telephony, SMS, video telephony, etc. over the IP domain
Manage 3G/4G radio availability and unavailability while providing seamless and transparent legacy services over either circuit switched or IP domains
Use the underlying 3G/4G data stack, for both native applications and third party applications, for IP based legacy services including end to end QoS for high bandwidth applications such as voice and video telephony over the IP domain
Provide native implementation for media recording, playback and audio/video sync services (e.g. with JSR281 style APIs abstracted in the HLOS user space) by accessing hardware codec implementation provided on a digital signal processor (DSP). In one example, this implementation will be used by both the native enabler engines for legacy services (e.g. voice, SMS, video telephony) or by third party applications written in the HLOS user space.

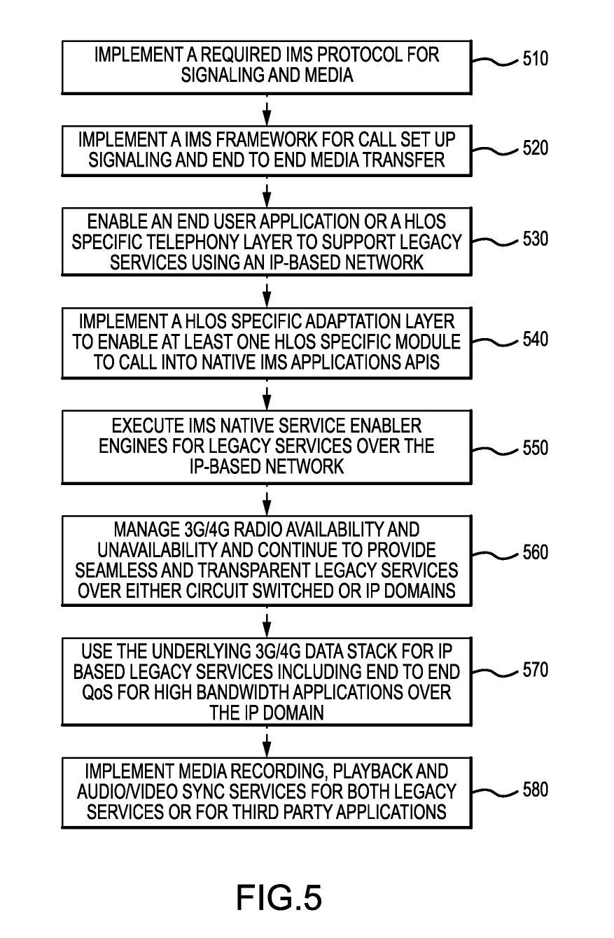

FIG. 5 illustrates an example process for providing Internet Protocol (IP) based services independent of platform or operating systems using IP multimedia subsystem (IMS). In block 510 implement a required IMS protocol for signaling and media. In block 520, implement an IMS framework for call set up signaling and end to end media transfer. In block 530, enable an end user application or a HLOS specific telephony layer to support legacy services using an IP-based network. In one example, legacy services may include voice, short messaging service (SMS), video, etc. In block 540 implement a HLOS specific adaptation layer to enable at least one HLOS specific module to call into a native IMS application program interface (API). In block 550, execute IMS native service enabler engines for legacy services over the IP-based network. In block 560, manage 3G/4G radio availability and unavailability and continue to provide seamless and transparent legacy services over either circuit switched or IP domains. In block 570, use the underlying 3G/4G data stack for IP based legacy services including end to end quality of service (QoS) for high bandwidth applications over the IP domain. In one example, high bandwidth applications include voice and video telephony. In 580, implement media recording, playback and audio/video sync services for both legacy services or for third party applications. In one example, the implementation follows the IMS Services API specified by JSR281.

One skilled in the art would understand that the steps disclosed in the example process in FIG. 5 can be interchanged in their order without departing from the scope and spirit of the present disclosure. Also, one skilled in the art would understand that the steps illustrated in the flow diagram are not exclusive and other steps may be included or one or more of the steps in the example flow diagram may be deleted without affecting the scope and spirit of the present disclosure.

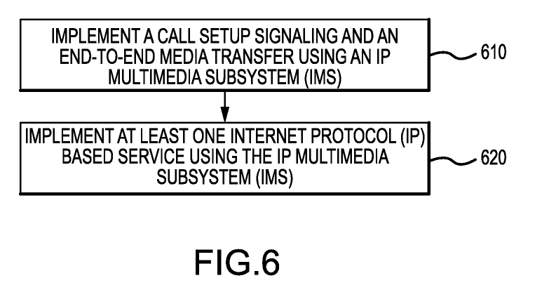

FIG. 6 illustrates an example flow diagram for providing Internet Protocol (IP) based services independent of platform or operating systems using IP multimedia subsystem (IMS). In block 610, implement a call setup signaling and an end-to-end media transfer using an IP multimedia subsystem (IMS). Following block 610, in block 620, implement at least one Internet Protocol (IP) based service using the IP multimedia subsystem (IMS). In one aspect, the implementation details of blocks 610 and 620 use one or more of the process steps described in FIG. 5. In one aspect, the steps in blocks 610 and 620 are implemented using one or more processors couple to one or more memory.

One skilled in the art would understand that the steps disclosed in the example flow diagram in FIG. 6 can be interchanged in their order without departing from the scope and spirit of the present disclosure. Also, one skilled in the art would understand that the steps illustrated in the flow diagram are not exclusive and other steps may be included or one or more of the steps in the example flow diagram may be deleted without affecting the scope and spirit of the present disclosure.

Those of skill would further appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art.

In one or more examples, the steps or functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

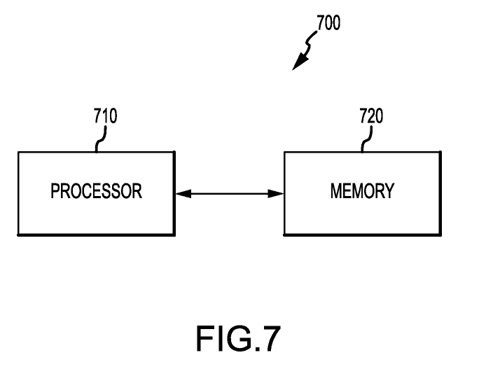

In one example, the illustrative components, flow diagrams, logical blocks, modules and/or algorithm steps described herein are implemented or performed with one or more processors. In one aspect, a processor is coupled with a memory which stores data, metadata, program instructions, etc. to be executed by the processor for implementing or performing the various flow diagrams, logical blocks and/or modules described herein. FIG. 7 illustrates an example of a device 700 comprising a processor 710 in communication with a memory 720 for executing the processes for providing Internet Protocol (IP) based services independent of platform or operating systems using IP multimedia subsystem (IMS). In one example, the device 700 is used to implement the algorithm illustrated in FIG. 6. In one aspect, the memory 720 is located within the processor 710. In another aspect, the memory 720 is external to the processor 710. In one aspect, the processor includes circuitry for implementing or performing the various flow diagrams, logical blocks and/or modules described herein.

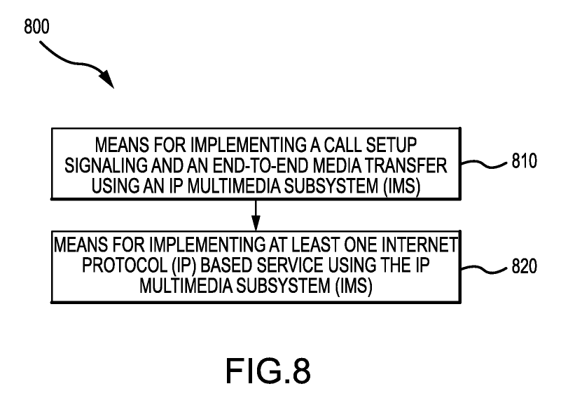

FIG. 8 illustrates an example of a first device 800 suitable for providing Internet Protocol (IP) based services independent of platform or operating systems using IP multimedia subsystem (IMS). In one aspect, the first device 800 is implemented by at least one processor comprising one or more modules configured to provide different aspects of providing Internet Protocol (IP) based services independent of platform or operating systems using IP multimedia subsystem (IMS) as described herein in blocks 810 and 820. For example, each module comprises hardware, firmware, software, or any combination thereof. In one aspect, the first device 800 is also implemented by at least one memory in communication with the at least one processor.

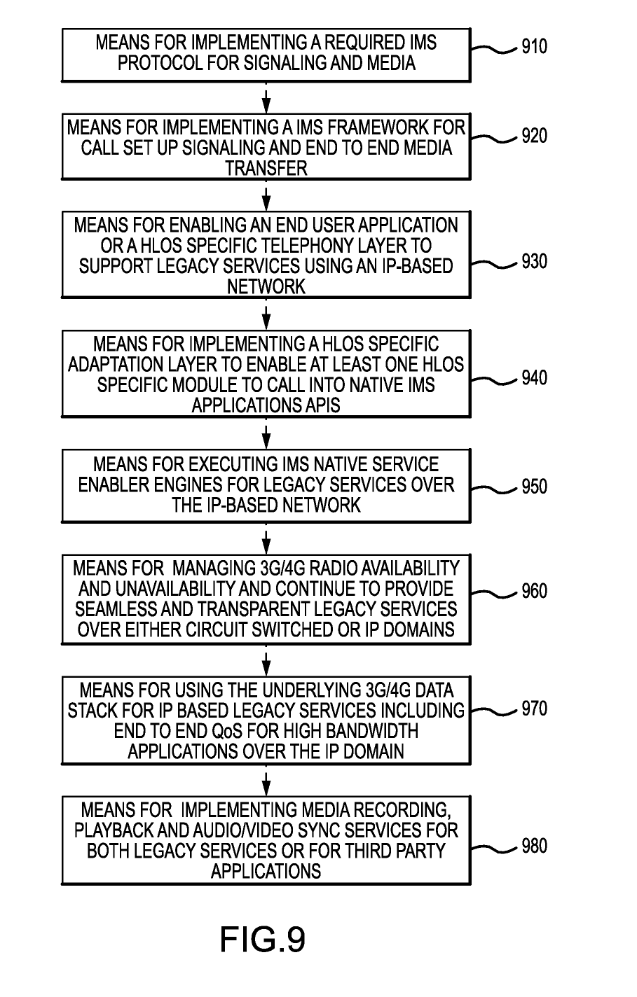

FIG. 9 illustrates an example of a second device 900 for providing Internet Protocol (IP) based services independent of platform or operating systems using IP multimedia subsystem (IMS). In one aspect, the second device 900 is implemented by at least one processor comprising one or more modules configured to provide different aspects of providing Internet Protocol (IP) based services independent of platform or operating systems using IP multimedia subsystem (IMS) as described herein in blocks 910, 920, 930, 940, 950, 960, 970 and 980. For example, each module comprises hardware, firmware, software, or any combination thereof. In one aspect, the second device 900 is also implemented by at least one memory in communication with the at least one processor.

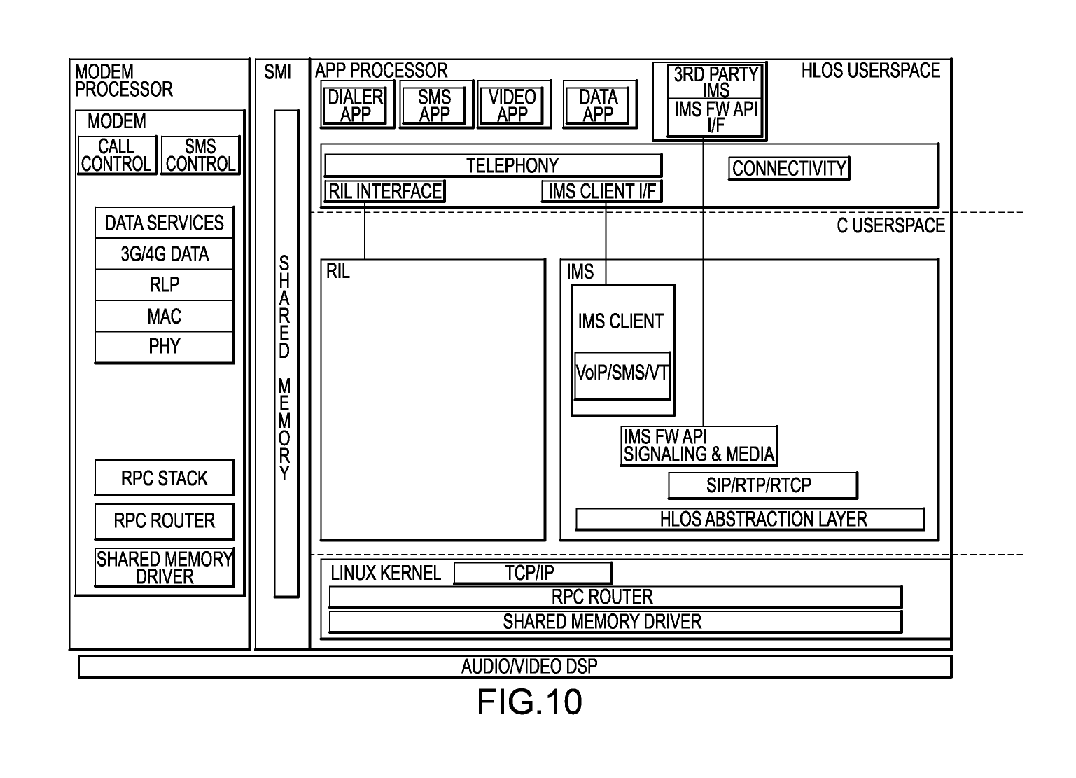

FIG. 10 illustrates an example processor configuration with both a modem processor and an application processor for providing Internet Protocol (IP) based services independent of platform or operating systems using IP multimedia subsystem (IMS). In one example, the air interface protocols, for example for 3G or 4G wireless systems, run on the modem processor. In another example, a 3G/4G data stack required for IP application support runs on the modem processor with remote access from the application processor. Also, call control and short messaging service (SMS) control is on the modem processor with remote access from the application processor. In one example, the modem processor runs a native operating system (OS) whereas the application processor could run any high level operating system (HLOS). Remote access from applications to the modem processor could be using some form of remote procedure call (RPC). In one aspect, all user applications, such as Dialer, SMS, data, video telephony, run on the application processor. A telephony layer provides the required framework to set up or teardown and manages voice, SMS and video applications. In addition, telephony layer interfaces with a Radio Interface Layer (RIL) and the IP Multimedia Subsystem (IMS) via separate interface layers. A connectivity layer manages the data and network connections on the desired 3G/4G interface.

In one aspect, the RIL runs on the application processor and provides an interface into the different radios (e.g. 3G/4G equipment) on the modem processor. IMS runs on the application processor and provides a native client of IP applications such as voice over IP (VoIP), SMS/IP, video telephony, etc. IMS uses IP based protocols such as Session Initiation Protocol (SIP), Real Time Transport Protocol (RTP), Real Time Transport Control Protocol (RTCP), etc. that are used for signaling (e.g. call setup) and media transfer. IMS uses a HLOS abstraction layer that abstracts the HLOS specific capabilities which makes IMS portable across different HLOS platforms on the application processor. IMS also hosts a Framework application program interface (API), for example, signaling and media based on a Java specification request (JSR), which can be used by third party IP applications which run on top of the HLOS on the application processor.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for providing at least one Internet Protocol (IP) based service independent of platform or operating systems using IP multimedia subsystem (IMS), the method comprising:
implementing a call setup signaling and an end-to-end media transfer using an IP multimedia subsystem (IMS); and
implementing the at least one Internet Protocol (IP) based service using the IP multimedia subsystem (IMS).

2. The method of claim 1 wherein the implementing the call setup signaling and the end-to-end media transfer step comprises one or more of the following:
implementing a required IMS protocol for signaling and media;
implementing an IMS framework for the call set up signaling and the end to end media transfer;
enabling an end user application or a high level operating system (HLOS) specific telephony layer to support at least one legacy service using an IP-based network;
implementing a high level operating system (HLOS) specific adaptation layer to enable at least one HLOS specific module to call into a native IMS application program interface (API);
executing an IMS native service enabler engine for at least one legacy service over the IP-based network;
managing 3^{rd} generation (3G)/4^{th} generation (4G) radio availability and unavailability and continuing to provide the at least one legacy service over either a circuit switched domain or an IP domain; or
using an underlying 3G/4G data stack for IP-based legacy service.

3. The method of claim 2 wherein the using the underlying 3G/4G data stack includes specifying an end to end quality of service (QoS) for high bandwidth applications over the IP domain.

4. The method of claim 3 wherein the end to end quality of service (QoS) is one of a bit rate, a transport delay, a jitter, a loss probability or a bit error rate (BER).

5. The method of claim 2 wherein the at least one legacy service is one of voice, short messaging service (SMS) or video.

6. The method of claim 2 wherein the IMS protocol for signaling and media includes a session initiation protocol (SIP) and a session description protocol (SDP).

7. The method of claim 6 further comprising using one or more of a real-time transport protocol (RTP) or a real-time transport control protocol (RTCP) for implementing the end to end media transfer.

8. The method of claim 2 further comprising using a protocol in a Java Specification Requests for implementing the IMS framework for the call set up signaling and the end to end media transfer.

9. The method of claim 2 wherein the at least one HLOS specific module is associated with one of Android, BREW or Windows Mobile (WM).

10. The method of claim 1 further comprising using a Session Initiation Protocol (SIP) including a Call Session Control Function (CSCF) for implementing the call set up signaling.

11. An apparatus for providing at least one Internet Protocol (IP) based service independent of platform or operating systems using IP multimedia subsystem (IMS), the apparatus comprising a processor and a memory, the memory containing program code executable by the processor for performing the following:
implementing a call setup signaling and an end-to-end media transfer using an IP multimedia subsystem (IMS); and
implementing the at least one Internet Protocol (IP) based service using the IP multimedia subsystem (IMS).

12. The apparatus of claim 11 wherein the memory further comprising program code for implementing the call setup signaling and the end-to-end media transfer by performing one or more of the following:
implementing a required IMS protocol for signaling and media;
implementing an IMS framework for the call set up signaling and the end to end media transfer;
enabling an end user application or a high level operating system (HLOS) specific telephony layer to support at least one legacy service using an IP-based network;
implementing a high level operating system (HLOS) specific adaptation layer to enable at least one HLOS specific module to call into a native IMS application program interface (API);
executing an IMS native service enabler engine for at least one legacy service over the IP-based network;
managing 3^{rd} generation (3G)/4^{th} generation (4G) radio availability and unavailability and continuing to provide the at least one legacy service over either a circuit switched domain or an IP domain; or
using an underlying 3G/4G data stack for IP-based legacy services.

13. The apparatus of claim 12 wherein the program code for using the underlying 3G/4G data stack further includes program code for specifying an end to end quality of service (QoS) for high bandwidth applications over the IP domain.

14. The apparatus of claim 13 wherein the end to end quality of service (QoS) is one of a bit rate, a transport delay, a jitter, a loss probability or a bit error rate (BER).

15. The apparatus of claim 12 wherein the at least one legacy service is one of voice, short messaging service (SMS) or video.

16. The apparatus of claim 12 wherein the IMS protocol for signaling and media includes a session initiation protocol (SIP) and a session description protocol (SDP).

17. The apparatus of claim 16 wherein the memory further comprising program code for using one or more of a real-time transport protocol (RTP) or a real-time transport control protocol (RTCP) for implementing the end to end media transfer.

18. The apparatus of claim 12 wherein the memory further comprising program code for using a protocol in a Java Specification Requests for implementing the IMS framework for the call set up signaling and the end to end media transfer.

19. The apparatus of claim 12 wherein the at least one HLOS specific module is associated with one of Android, BREW or Windows Mobile (WM).

20. The apparatus of claim 11 wherein the memory further comprising program code for using a Session Initiation Protocol (SIP) including a Call Session Control Function (CSCF) for implementing the call set up signaling.

21. An apparatus for providing at least one Internet Protocol (IP) based service independent of platform or operating systems using IP multimedia subsystem (IMS), the apparatus comprising:
means for implementing a call setup signaling and an end-to-end media transfer using an IP multimedia subsystem (IMS); and
means for implementing the at least one Internet Protocol (IP) based service using the IP multimedia subsystem (IMS).

22. The apparatus of claim 21 wherein the means for implementing the call setup signaling and the end-to-end media transfer comprises one or more of the following:
means for implementing a required IMS protocol for signaling and media;
means for implementing an IMS framework for the call set up signaling and the end to end media transfer;
means for enabling an end user application or a high level operating system (HLOS) specific telephony layer to support at least one legacy service using an IP-based network;
means for implementing a high level operating system (HLOS) specific adaptation layer to enable at least one HLOS specific module to call into a native IMS application program interface (API);
means for executing an IMS native service enabler engine for at least one legacy service over the IP-based network;
means for managing 3^{rd} generation (3G)/4^{th} generation (4G) radio availability and unavailability and continuing to provide the at least one legacy service over either a circuit switched domain or an IP domain; or
means for using an underlying 3G/4G data stack for IP-based legacy services.

23. The apparatus of claim 22 wherein the means for using the underlying 3G/4G data stack includes means for specifying an end to end quality of service (QoS) for high bandwidth applications over the IP domain.

24. The apparatus of claim 23 wherein the end to end quality of service (QoS) is one of a bit rate, a transport delay, a jitter, a loss probability or a bit error rate (BER).

25. The apparatus of claim 22 wherein the at least one legacy service is one of voice, short messaging service (SMS) or video.

26. The apparatus of claim 22 wherein the IMS protocol for signaling and media includes a session initiation protocol (SIP) and a session description protocol (SDP).

27. The apparatus of claim 26 wherein the means for implementing the end to end media transfer further comprises means for using one or more of a real-time transport protocol (RTP) or a real-time transport control protocol (RTCP).

28. The apparatus of claim 22 wherein the means for implementing the IMS framework for the call set up signaling and the end to end media transfer further comprises means for using a protocol in a Java Specification Requests.

29. The apparatus of claim 22 wherein the at least one HLOS specific module is associated with one of Android, BREW or Windows Mobile (WM).

30. The apparatus of claim 21 wherein the means for implementing the call set up signaling further comprises means for using a Session Initiation Protocol (SIP) including a Call Session Control Function (CSCF).

31. A computer-readable medium storing a computer program for providing at least one Internet Protocol (IP) based service independent of platform or operating systems using IP multimedia subsystem (IMS), wherein execution of the computer program is for:
implementing a call setup signaling and an end-to-end media transfer using an IP multimedia subsystem (IMS); and
implementing the at least one Internet Protocol (IP) based service using the IP multimedia subsystem (IMS).

32. The computer-readable medium of claim 31 wherein the program code for implementing the call setup signaling and the end-to-end media transfer further comprises program code for one or more of the following:
implementing a required IMS protocol for signaling and media;
implementing an IMS framework for the call set up signaling and the end to end media transfer;
enabling an end user application or a high level operating system (HLOS) specific telephony layer to support at least one legacy service using an IP-based network;
implementing a high level operating system (HLOS) specific adaptation layer to enable at least one HLOS specific module to call into a native IMS application program interface (API);
executing an IMS native service enabler engine for at least one legacy service over the IP-based network;
managing 3^{rd} generation (3G)/4^{th} generation (4G) radio availability and unavailability and continuing to provide the at least one legacy service over either a circuit switched domain or an IP domain; or
using an underlying 3G/4G data stack for IP-based legacy services.

33. The computer-readable medium of claim 32 wherein the using the underlying 3G/4G data stack includes specifying an end to end quality of service (QoS) for high bandwidth applications over the IP domain.

34. The computer-readable medium of claim 33 wherein the end to end quality of service (QoS) is one of a bit rate, a transport delay, a jitter, a loss probability or a bit error rate (BER).

35. The computer-readable medium of claim 32 wherein the at least one legacy service is one of voice, short messaging service (SMS) or video.

36. The computer-readable medium of claim 32 wherein the IMS protocol for signaling and media includes a session initiation protocol (SIP) and a session description protocol (SDP).

37. The computer-readable medium of claim 36 wherein execution of the computer program is also for using one or more of a real-time transport protocol (RTP) or a real-time transport control protocol (RTCP) for implementing the end to end media transfer.

38. The computer-readable medium of claim 32 wherein execution of the computer program is also for using a protocol in a Java Specification Requests for implementing the IMS framework for the call set up signaling and the end to end media transfer.

39. The computer-readable medium of claim 32 wherein the at least one HLOS specific module is associated with one of Android, BREW or Windows Mobile (WM).

40. The computer-readable medium of claim 31 wherein execution of the computer program is also for using a Session Initiation Protocol (SIP) including a Call Session Control Function (CSCF) for implementing the call set up signaling.
